(19) United States
(12) Patent Application Publication
(10) Pub. No.: US 2010/0297289 A1
(43) Pub. Date: Nov. 25, 2010

(54) Composition for Stabilising a Dietary Aqueous Liquid Sensitive to Oxidation

(76) Inventors: Jean-Michel Salmon, Castelnau (FR); Michel Moutounet, Montpellier (FR); Jean-Claude Boulet, Vinassan (FR)

Correspondence Address: GREENLEE SULLIVAN P.C., 4875 PEARL EAST CIRCLE, SUITE 200, BOULDER, CO, 80301, US

(21) Appl. No.: 12/863,965

(22) PCT Filed: Jan. 22, 2009
(86) PCT No.: PCT/FR09/50087

§ 371 Date: Jul. 21, 2010

(30) Foreign Application Priority Data
Jan. 23, 2008 (FR) 0850421

(51) Int. Cl. C12G 1/00; A23L 1/28; C12H 1/14

(52) U.S. Cl. 426/12; 426/62; 426/60; 426/592

(57) ABSTRACT

The present invention relates to a composition for protecting from oxidation a dietary liquid, which contains substances sensitive to oxidation during the shelf-life thereof including a combination of two types of yeast cells:
(i) non-viable yeast cells that are capable of rapidly consuming oxygen, and
(ii) glutathione-enriched inactivated yeast cells.

### FIELD OF THE INVENTION

The present invention relates to the field of food preservation of liquids which could be altered through oxidation phenomena.

### PRIOR ART

Generally speaking, there is a constant need for developing new methods for stabilizing dietary aqueous liquids that are sensitive to oxidation, in order to improve the storage conditions thereof or to extend their shelf-life.

Drawbacks relating to the deterioration of physico-chemical or organoleptic properties of aqueous liquids for use in human food or animal feeding have been well known for a long time. Solutions to overcome such drawbacks have already been described according to the state of the art.

Means that are known to reduce or to block the oxidation of dietary aqueous liquids during the shelf-life thereof include: (i) physical means, (ii) means implementing chemical agents with anti-oxidizing properties and (iii) means implementing biological agents, for example microorganisms.

Among the various mechanical means, one can cite the means that enable the removal of dissolved oxygen in liquids such as:
a method for pressurizing the liquid, preferably a fruit juice, by using gaseous nitrogen, such as described in the patent JP 2006/141319;
an oxygen-absorbing film placed onto the surface of the liquid to be protected, such as described in the patent application JP 6100044;
a double-layer film so as to isolate the liquid to be protected, wherein the outer layer is impervious to oxygen and the inner layer may absorb oxygen, such as described in the patent application JP 5319459;
a method for depositing a layer of an inert gas denser than air that is compatible with food onto the surface of liquids, in particular of drinks exposed to oxygen in an open container, such as described in the patent application EP 0 134 687.

Chemical treating means used for stabilizing liquids for dietary use against oxidation, in particular fermented drinks, more particularly wines include the use of PVP (polyvinylpyrrolidone), of ascorbic acid and/or sulfite (SO₂). Nevertheless such methods to chemically stabilize against oxidation could be strictly regulated in the future and could even be prohibited for some of these methods.

Known biological means include the use of microorganisms such as bacteria of kefir grains as antioxidizing additives, especially for drinks, as described in the patent application EP 1 607 476.

Depending on the type of the dietary aqueous liquid, the oxidation reactions of the substances contained in these liquids, during the shelf-life thereof, cause the deterioration to a greater or lesser extent of their physico-chemical or organoleptic properties.

Amongst the dietary aqueous liquids for which oxidation causes deteriorations which make them unfit for human consumption, there are first of all wines, and, in ascending order of importance, the white wine.

Oxidation reactions which occur in wines, especially in white wines, rosé wines and in some red wines, do lead to the loss of wine varietal flavors, to a modified organoleptic profile and to a brown coloration of wines. These unwanted changes are due, at least in part, to oxidation reactions.

The browning of white wines, especially, is said to be caused by oxidation polymerization reactions of some polyphenols. Some polyphenols, upon reacting with oxygen, are converted to quinones and semiquinones. Those highly reactive compounds do complex with other sulfanyl function-containing compounds, such as volatile thiols, and result in brown pigments. Such complexation reaction with quinones and semiquinones spoil the aromatic properties of the volatile thiols.

White wines are produced so as to obtain fresh, fruity wines, to be consumed quickly, or laying down “premium” wines aged for several years.

It is essential to protect wines from oxidation and from browning which could alter their organoleptic profile. In particular, flavor deterioration and browning have a negative organoleptic impact resulting in a high depreciation on sale, and as a consequence a significant economic loss.

As soon as white wines are conditioned in various containers, following the filtration step performed after the end of the fermentation process, they are continuously exposed to the oxygen of air. Indeed, some oxygen is captured together with white wine, during the conditioning. Thereafter, as containers generally are not completely gas-tight, some oxygen enters into container during all the time the wine takes to age during the shelf-life thereof. Many solutions have been contemplated to prevent such browning and the organoleptic deteriorations that are associated therewith, due to the contact of the wine with oxygen during the shelf-life thereof, such as consisting in:
limiting the exposure to oxygen,
using natural or synthetic antioxidants or,
removing polyphenols that are responsible for the browning phenomenon.

However, with the techniques used nowadays to condition aqueous liquids for dietary use, including wines, it is very difficult to totally avoid any contact of said liquids with oxygen in air during their transportation and up to the conditioning unit.

In addition, after glass bottle conditioning, oxygen may diffuse through the bottle cork or from the gas headspace located under the bottle cork after bottle filling.

In the case of wine, the contact with oxygen in air also occurs with other types of conditioning, such as in wineskins or BIBS® (Bag-In-Box). In BIB®s, wine is conditioned under vacuum in a plastic bag, said plastic bag being housed within a carton. The plastic bag is made of a material acting as a barrier against oxygen on its external surface, but is not totally oxygen-tight.

For limiting or blocking oxidation reactions in wine during the shelf-life thereof, the addition of antioxidizing chemical agents such as sulfite (SO₂) so as to inhibit the oxidation of the wine sensitive components is very limited because of the regulation on food products. Sulfur dioxide added in excess may also impair the wine organoleptic quality.

For removing the polyphenols so as to correct the browning of white wines, finingagents are commonly used, such as activated carbon or PVPP (polyvinylpyrrolidone) (Fialdes, E., Rev. des enologists, 1989, 54, 19-22; Baron, R. and al., Z. Lebensm. Unters Forsch, 1997, 205, 474-78). However, these substances unfortunately impair the flavors and tastes of wines (Sims, C. A., and al., Am. J. Enol. Vitic; 1995, 46 (2), 155-158). Moreover, some polyphenols such as resveratrol have very interesting physico-chemical and organoleptic properties in terms of health and nutrition and their removal should as far as possible be avoided.

Academic research studies did reveal that adding to a white wine 10 mg/L of glutathione during the bottling limits the yellowing of its color, the decline of its flavor as well as its bad-ageing tendency. Glutathione could react during maturing or after bottling, with quinones to form a colorless complex, thus preventing said quinones from reacting with numerous sulfanyl function-containing compounds amongst which the thiols present in the wine (aromatic molecules), which normally results in a brown complex and inhibits the aromatic expression.

However these results cannot be transposed in practice by the growers because adding glutathione to wine as a finished product is not allowed in the enological practice. In addition, introducing glutathione into the grape raises the problem of its consumption by inoculated active yeasts during alcoholic fermentation.

Thus, while these studies are interesting for a better understanding of the phenomena involved in the deterioration of flavors and the browning of white wines, they do not suggest any technical solution to solve these problems in practice.

As already mentioned, it has also been contemplated to use some biological agents for restraining the oxidation phenomena resulting from the presence of oxygen, in particular through the use of oxygen-consuming yeasts.

The European patent application n° EP 0 305 005 B1 describes the use of oxygen-consuming yeasts for limiting oxidation phenomena in water-containing products during the shelf-life thereof. This patent application especially describes a yeast and a method which both are more particularly suitable for preserving beer. The yeasts that are used consist in dehydrated yeasts which are subsequently rehydrated with the water contained in beer. Once rehydrated, these yeasts are viable and do multiply. To prevent any formation of turbidity in beer as a result of the multiplication of the oxygen-consuming yeasts, these cells of yeasts are immobilized on solid supports which are compatible with the food standards, such as waxes or gums. These supports are pervious to water and oxygen. During the pasteurization step, carried out for conditioning beer, yeast cells remain viable, capable of consuming oxygen. This oxygen consumption does not occur through a fermentation reaction.

In order to remedy to oxidation phenomena during wine ageing or storage, it has been suggested to treat wine with baker's yeast cells (Bonilla and al., J. Agric. Food Chem., 2001, 49, 1928-1933). Indeed, the yeast membranes have the capacity to retain some compounds, and in particular coloring substances such as anthocyans. Wines have been treated with yeast concentrations ranging from 0.5 g/L to 5 g/L for 24 hours, and then have been filtered off. An effect onto colors could be observed, while the gustative properties were preserved. But this technique which belongs to “clean technologies”, has the drawback of requiring a subsequent microbiological sterilization in order to prevent residual yeast cells to multiply and deteriorate the transparency as well as the organoleptic properties of the thus treated wine.

The application PCT n° WO 2005/080543 describes a method for producing wine while preventing the oxidation problems encountered upon wine ageing, preferably white wine, by introducing into the grape must glutathione-enriched yeast before fermentation onset, preferably at the beginning or during fermentation. Thanks to this method, it is possible by exclusively using natural ingredients to obtain high-quality white wines satisfying the following criteria: texture/body, freshness and fruitiness of wine, flavor time stability, color time stability. There is no need for any foreign substance addition such as chemical antioxidants, or for any complex handling.

According to the application PCT no WO 2005/080543, it is recommended to introduce glutathione-enriched yeasts into the grape must in the beginning of the fermentation.

Wine post-fermentation treatments to obtain a final product that can suitably undergo maturation or be consumed, in particular the filtration steps enables the removal of glutathione-enriched yeasts. When white wine is stored in a container, problems of oxidation, browning, loss of taste and odor properties thus remain unsolved.

Therefore, there is still a need for new methods for stabilizing dietary aqueous liquids, that would suitably protect said liquids from oxygen-mediated oxidation during the shelf-life thereof.

### SUMMARY OF THE INVENTION

It is an object of the invention to provide a composition, for protecting a dietary liquid, which contains substances sensitive to oxidation during the shelf-life thereof from oxidation, comprising a combination of two types of yeast cells: (i) non-viable yeast cells selected for their ability to rapidly consume oxygen and (ii) inactivated yeast cells produced in such a manner to be rich in glutathione.

It is another object of the present invention to provide a method for stabilizing a dietary aqueous liquid, which contains substances sensitive to oxidation during the shelf-life thereof, comprising a step consisting in contacting said liquid with said yeast cell composition.

The present invention also relates to a treatment performed so as to reduce the oxydoreduction potential of a dietary aqueous liquid to thus promote the optimal expression of some compounds in redox balance in said liquid, which, in their reduced form, are interesting in terms of organoleptic properties.

The present invention also relates to a final white wine, stabilized by means of the hereabove method, which does not present any naked-eye detectable browning, and which has an oxydoreduction potential of at most equivalent to the oxydoreduction potential prevailing at the time of its conditioning and which concentrations of compounds impacting on the organoleptic properties of said wine are at least equal to the concentrations of said compounds prevailing at the time of its conditioning.

It is a further object of the present invention to provide the use of the hereabove yeast cell composition to stabilize, during the shelf-life thereof, dietary aqueous liquids as previously defined against oxidation.

### DESCRIPTION OF THE FIGURES

To further explain the present invention, references will be now made to the appended figures, amongst which:

FIG. 1 shows the evolution of the oxygen content over time in a wine in the presence of either dregs (Dregs), or OptiWhite® yeasts (OW), or in the presence of the composition of the invention (here in the presence of dregs and OptiWhite® yeasts (D+OW)). The curve A2 represents the oxygen evolution curve for control wine. (that is to say with no dregs and no OptiWhite® yeasts). The curve Temp/2 shows the temperature evolution as a function of time. The x-coordinate represents days and the y-coordinate represents the O₂ content (mg/L) for the curves A2, Dregs, OW and L+W or the temperature in ° C. divided by half for the curve Temp/2.

FIG. 2a shows the average evolution of parameter “L” per category for Dregs, OptiWhite® yeasts and the composition of the invention, parameter “L” being one of the CIE 1976 chromatic parameters. The x-coordinate represents days and the y-coordinate represents the value of parameter “L”.

FIG. 2b shows the average evolution of parameter “a” per category for Dregs, OptiWhite® yeasts and the composition of the invention, parameter “a” being one of the CIE 1976 chromatic parameters. The x-coordinate represents days and the y-coordinate represents the value of parameter “a”.

FIG. 2c shows the average evolution of parameter “b” per category for Dregs, OptiWhite® yeasts and the composition of the invention, parameter “b” being one of the CIE 1976 chromatic parameters. The x-coordinate represents days and the y-coordinate represents the value of parameter “b”.

FIG. 3a shows the evolution of the residual content of dissolved oxygen for a wine stored in a control glass bottle provided with a bottle cork and the evolution of the residual content of dissolved oxygen for a wine stored in a glass bottle provided with a bottle cork and contacted with the composition of the invention. The x-coordinate represents the time as expressed in days and the y-coordinate represents the dissolved oxygen content (mg/L).

FIG. 3b shows the evolution of the oxydoreduction potential for a wine stored in a control glass bottle provided with a bottle cork and the evolution of the oxydoreduction potential for a wine stored in a glass bottle provided with a bottle cork and contacted with the composition of the invention. The x-coordinate represents the time as expressed in days and the y-coordinate represents the oxydoreduction potential (mV).

FIG. 3c shows the evolution of the glutathione content for a wine stored in a control glass bottle provided with a bottle cork and the evolution of the glutathione content for a wine stored in a glass bottle provided with a bottle cork and contacted with the composition of the invention. The x-coordinate represents the time as expressed in days and the y-coordinate represents the glutathione content (mg/L).

FIGS. 4a, 4b and 4c represent the evolution of the chromatic characteristics, respectively parameters “L”, “b” and “a”, for a wine stored in a control glass bottle provided with a cork and the evolution of the chromatic characteristics for a wine stored in a glass bottle provided with a bottle cork and contacted with the composition of the invention. The x-coordinate represents the number of days at 30° C. and the y-coordinate represents the value of parameters “L”, “a” and “b”.

### DETAILED DESCRIPTION OF THE INVENTION

The present invention provides compositions and methods that are intended to stabilize dietary aqueous liquids against oxidation throughout the shelf-life thereof.

The present invention provides a composition for protecting a dietary liquid containing substances sensitive to oxidation from oxidation during its shelf-life, the said composition comprising a combination of two types of yeast cells:
(i) non-viable yeast cells that are capable of rapidly consuming oxygen, and
(ii) glutathione-enriched inactivated yeast cells.

The hereabove composition provides a simple and economic solution for stabilizing against oxidation a dietary aqueous liquid, which contains substances sensitive to oxidation, very especially during the shelf-life thereof.

The stabilizing effect of the composition of the invention against oxidation is illustrated in particular by the stabilization of the color, t that of the varietal flavors sensitive to oxidation, and more generally that of the organoleptic properties of the dietary aqueous liquid which has been treated with the said composition.

Preferably, a “dietary aqueous liquid, which contains substances sensitive to oxidation”, as used herein, is intended to mean drinks for human consumption.

Drinks for human consumption include drinks selected in the group consisting (i) of fruit or vegetable juices, (ii) fermented drinks, (iii) milk, (iv) milk-based liquid or semi-liquid prepared compositions, fermented or not, and (v) tea.

Fermented drinks include wine, beer, cider, sake and liquid yoghurt, the so called “drinking yoghurt”.

As used herein, a “wine” is intended to mean the product resulting from the total or partial alcoholic fermentation, of fresh grape berries, treaded or not, or that of grape musts.

Preferably, said substances that are sensitive to oxidation are polyphenols.

Preferably, a “dietary aqueous liquid, which contains substances sensitive to oxidation”, as used herein, is intended to mean drinks for human consumption comprising at least 1 mg of polyphenols per liter of said liquid.

Said liquid, which contains substances sensitive to oxidation is preferably selected in the group consisting of beers, fruit juices, wines highly sensitive to oxygen, and other oxygen-highly sensitive drinks.

Wines include white wines, rosé wines and red wines.

Even more particularly, wines include generally speaking all white wines, which are known to be highly sensitive to oxidation, as well as some rosé and red wines.

Thus, most preferably, said dietary aqueous liquid consists in a white wine.

As used herein, a “protection against oxidation, or a stabilization, of a dietary aqueous liquid, which contains substances sensitive to oxidation”, is intended to mean a reduction or an inhibition of the oxidation reactions of some compounds such as polyphenols contained in said liquid and of said oxidation reactions on the physico-chemical and organoleptic properties that make said liquid appropriate for human consumption.

During the shelf-life thereof, white wines may suffer from a varietal flavor loss, a change in their organoleptic profile, as well as from a browning. As used herein, “stabilizing a white wine” is particularly intended to mean a protection against unwanted aromatic and chromatic changes resulting from oxidation.

According to the invention, non-viable yeast cells or inactivated yeast cells have in common the loss of their ability to reproduce and to ferment.

As used herein, “non-viable yeast cells capable of rapidly consuming oxygen” are intended to mean yeast cells which have loss their ability to multiply and possess a higher reaction rate with oxygen and a higher affinity for oxygen as compared to those of said substances sensitive to oxidation, as illustrated in example 1. In a preferred embodiment, these yeast cells have been beforehand selected for their ability to rapidly consume oxygen.

The ability of non-viable yeast cells to rapidly consume oxygen is illustrated especially by their oxygen consumption rate.

The oxygen consumption rate by yeast cells introduced into a given medium may be determined from the oxygen content evolution kinetics in said medium as a function of time. The amount of oxygen present in the medium as a function of time may be determined through oxygen assay methods that are well known from the person skilled in the art. Especially, the person skilled in the art may use an oximeter suitable for measuring oxygen in a liquid medium. In some embodiments, the oxygen amount is measured as a function of time by means of an oximeter provided with a polarographic or a galvanic sensor as illustrated in example 1.

Whatever the measurement configuration, the yeast concentration in the medium should be of about 10⁸ cells per ml for enabling an accurate measurement of their oxygen consumption.
Preferably, the medium used for determining the yeast oxygen consumption rate is a hydroalcoholic medium optionally comprising substances sensitive to oxidation.

As used herein, a “hydroalcoholic medium” is intended to mean a medium resulting from the combination of an aqueous solution with ethanol, wherein the ethanol percentage does preferably range from 5% to 20% by volume relating to the medium total volume.

The inventors showed that non-viable yeast cells having an oxygen consumption rate of at least 5 ng O₂ s⁻¹ for 10¹⁰ yeast cells in a CMP buffer (hydroalcoholic medium described in example 1) at a cell concentration of about 10⁸ cells/ml are sufficiently able to rapidly consume oxygen in view of the present invention.

In some preferred embodiments, the non-viable yeasts capable of rapidly consuming oxygen consist in yeast cells having an oxygen consumption rate of at least 5 ng O₂ s⁻¹ for 10¹⁰ yeast cells when said yeast cells are present at a concentration of about 10⁸ cells/ml in a hydroalcoholic buffer.

As used herein, an oxygen consumption rate of at least 5 ng O₂ s⁻¹ for 10¹⁰ yeast cells, does preferably mean an oxygen consumption rate of at least 5, 10, 15, 20, 25, 30, 35, 40, 45, 50 ng O₂ s⁻¹ for 10¹⁰ yeast cells.

Preferably, non-viable yeast cells capable of rapidly consuming oxygen have an oxygen consumption rate ranging from 5 ng O₂ s⁻¹ to 40 ng O₂ s⁻¹ for 10¹⁰ yeast cells.

As used herein, a concentration of about 10⁸ cells/m¹ is intended to mean a concentration ranging from 10⁷ to 10⁹ cells/ml.

In some embodiments of the composition, non-viable yeast cells capable of rapidly consuming oxygen may be selected in the group consisting of yeast dregs and inactivated yeast cells.

As used herein, “inactivated yeast cells” are intended to mean yeast cells which have been subjected to a treatment making them unable to multiply and ferment. Such a treatment may be for example a thermal, a chemical and/or a radiation treatment.

As a non-limitative illustration, one may cite as suitable inactivated yeast cells the thermally inactivated EC1118 strain as illustrated in example 8 of the present application.

In some embodiments, dregs of yeasts derived from wine fermentation are chosen as non-viable yeast cells capable of rapidly consuming oxygen. Indeed, dregs represent large amounts of non-viable yeast cells at the end of the fermentation process of the wine-making method. These non-viable yeast cells comprise large amounts of molecules which are substrates of oxidation reactions and which are masked in living cells, especially during the cell multiplication (see for example Formairon and al., 2000. Food Chemistry, Ed Elsevier, pp. 519-528).

During the fermentation process, during the wine-making process for example, it has been demonstrated that the oxygen consumption by dregs could counteract oxidation phenomena, which negatively affect the wine organoleptic properties, occurring after the addition of oxygen in the medium (see for example Salmon and al., 2003, Daynal of Bioscience and Bioengineering, pp. 496-503). Surprisingly, implementing the composition of the invention has shown that these dreg properties are useful for protecting finished wines during their storage life from unwanted oxidation phenomena.

In some embodiments, non-viable yeast cells are dregs of yeasts obtained from a yeast culture in a fermentation medium that reproduces the natural grape must conditions.

As a non-limitative illustration, one may cite a synthetic medium enriched in available nitrogen, such as medium MS300, as an example of fermentation medium reproducing the conditions of natural grape conditions.

As a non-limitative illustration, one may cite yeast dregs of Saccharomyces cerevisiae K1 obtained from the culture of said yeasts in the synthetic medium MS300 as an example of non-viable yeast cells having an oxygen consumption of at least 5 ng.O₂ s⁻¹ for 10¹⁰ yeast cells0. The method for obtaining the said dregs and the method for determining their rate of oxygen consumption are described in example 1.

Yeast dregs may be expected to consume the oxygen present in any type of liquids containing oxygen-reactive substances. The oxygen consumption capacity of these non-viable yeast cells may be higher than that of dehydrated viable cells and that of inactivated cells, as illustrated in example 2.

In some embodiments of the composition of the invention, non-viable yeast cells capable of rapidly consuming oxygen consist in yeast cells of the Saccharomyces cerevisiae species.

Generally speaking, the glutathione-enriched inactivated yeast cells consist in yeast cells which have been specifically produced in order to contain a large amount of glutathione and to release a large amount of glutathione in the external medium.

In some embodiments of the composition, said glutathione-enriched inactivated yeasts are yeasts such as described in the application PCT no WO2005/080543. They are characterized by the glutathione content assay according to the method of example 1, page 8 of the application WO 2005/080543.

Without wishing to be bound by any theory, the applicant thinks that the glutathione released by the gluthatione-enriched yeast, reacts during maturing or after bottling, with the quinones to form a colorless complex which prevents the said quinones from reacting: (i) with the sulfanyl-function chemical compounds including wine thiols (aromatic molecules), the said reaction leading to a reduction of the aromatic expression and (ii) with other phenolic compounds to form complex pigments with a yellow to brown varying color which impair the product color.

Yeast cells do naturally contain some amount of glutathione, typically ranging from 0.2% by weight to 0.5% by weight, related to the dry matter total weight, i.e. from 0.2 g to 0.5 g of glutathione for 100 g of yeast dry matter.

The production of glutathione-enriched yeast cells is well known from the person skilled in the art who is familiar with the various production methods available (Catalino and al., 1992, Applied Microbiology and Biotechnology, Ed Springer-Verlag, pp. 141-146).

Yeast may be enriched with glutathione by exposing it to cysteine, under culture optimal conditions, where said yeast may diffuse through the medium up to 154.54 mg/L of glutathione after a 72-hour fermentation, (see Santos and al., 2007, Applied Microbiology and Biotechnology, Ed. Springer, pp. 1211-1216).

Glutathione-enriched yeasts that are used for preparing the composition of the invention, comprise more than 0.5% by weight of glutathione, relative to the yeast dry matter total weight. Advantageously, glutathione-enriched yeast comprises at least 1% by weight of glutathione, and preferably at least 1.5% by weight of glutathione, relative to the yeast dry matter total weight. For example, for an optimum efficiency, a yeast which enriched in gluthatione at 1.8% by weight relative to the yeast cell total weight is used.

Said glutathione-enriched yeasts may be inactivated through any method known from the person skilled in the art, as for example using a thermal or a chemical treatment, and optionally by irradiation, using for instance a radioactive radiation or an ultraviolet radiation. Said inactivated yeasts are non viable and are neither capable of growing nor of fermenting anymore.

In some advantageous embodiments, glutathione-enriched yeast cells according to the invention belong to yeast species of the enological type, including Saccharomyces cerevisiae.

Yeast species of the enological type include Saccharomyces cerevisiae.

The combination of (i) non-viable yeast cells capable of rapidly consuming oxygen and (ii) glutathione-enriched inactivated yeast cells, in a stabilizing composition of the invention, provides an efficient protection of wine against oxidation phenomena, for protecting both the color and the varietal flavors sensitive to oxidation, and more generally speaking the organoleptic quality. This synergism is illustrated in the following examples hereunder.

As used herein, the expression “during the shelf-life thereof” or “during the storage life” is intended to mean the time period during which the composition of the invention is implemented. A dietary aqueous liquid is considered as being “under storage” from the moment when it is conditioned in a stock holder and stored in a place promoting its stabilization. The storage temperature of a dietary aqueous liquid varies depending on the type of the aqueous liquid which is considered. For example, a fruit juice that has been pasteurized and preserved in a sterile manner may be stored at room temperature, that is to say at a temperature of about 20° C., or even at a temperature of 20° C. The storage temperature of a fresh, non pasteurized fruit juice should be low in order to avoid the proliferation of potential microorganisms that may be contained in the said juice, the said temperature generally ranging from 1° C. to 7° C., preferably from 3° C. to 5° C. The long term storage temperature for a wine does classically range from 10° C. to 17° C., advantageously from 11° C. to 15° C. and is preferably of about 12° C. However, whatever the dietary aqueous liquid considered, the optimal temperature conditions for preservation are not always observed during the transportation period, the transportation period may sometimes last several days, even more than a week, as in the case, for example, of a intercontinental transportation of very long distance performed by seaway.

If the transportation of the dietary aqueous liquid occurs under temperature conditions significantly higher than the predefined optimum temperature, these non controlled temperature conditions may cause the deterioration of the properties of said dietary aqueous liquid, for example lead to an acceleration of the oxidation reactions.

And yet the applicant showed that the composition of the invention retains its activity for protecting a dietary aqueous liquid against oxidation up to high temperatures of at least 30° C. As a consequence, the composition of the invention is active for stabilizing dietary aqueous liquids against oxidation during the all storage life of said liquid, including the transportation time period wherein the optimum conditions of preservation cannot always be observed. In addition, the composition of the invention is also active when the storage temperature is not optimum anymore, for example when temperature control devices become out of order, or in the event of a high temperature climatic period.

In a preferred embodiment of a stabilizing composition according to the invention, the yeast cells are incorporated together into an immobilization system that is pervious to liquids. Said immobilization system is made of materials compatible with the food standards. Said materials may be, without limitation, membrane capillaries, silicone tubes or additives of the texturizing agent or gelling agent type.

The yeast cells and the immobilization system in which they are incorporated, preferably immobilized, as a whole, consists in a composition according to the invention of the “Immobilized Antioxidant Biosystem” type.

In one embodiment of a composition according to the invention, both types of yeast cells are immobilized together onto an alginate-based support, which is both a food texturizing additive and a food macromolecule with cross-linking property.

As an illustration, said cells are immobilized in a gel prepared from polysaccharides such as calcium alginate (ionotropic gel formation) or potassium carrageenate (thermoreversible gel).

Techniques for immobilizing yeast cells in a calcium alginate matrix have been described in particular by Kawaguti and al., 2006, Biochemical Engineering Daynal 29, 270-277.; Lu & Wilkins, 1996 Daynal of Hazardous Materials 49, 165-179.; Podrazky & Kuncova, 2005, Sensors and Actuators B: Chemical 107, 126-134; Riordan and al., 1996, Bioresource Technology 55, 171-173).

For example, for preparing a stabilizing composition according to the invention, yeast cells may be immobilized in an alginate support by mixing a 3% sodium alginate solution (p/v) with a solution containing the cells to be immobilized. Thereafter said combination is poured dropwise into a calcium chloride solution (0.15 M) in order to produce alginate beads containing the yeast cells.

Semi-industrial tests conducted on white wine described in example 5 illustrate the efficiency of the yeast cell combination of the invention when immobilized in an alginate support.

Advantageously, this preferred embodiment of a composition according to the invention enables to control the distribution of the inactive yeasts within the container, so that the said inactive yeasts are located as near as possible to an oxidation zone. Moreover it makes it possible to easily remove, by any suitable mechanical mean, the yeast cells from the dietary aqueous liquid which contains substances sensitive to oxidation at a time selected by the person skilled in the art as being the most appropriate, for example at the time when the claimed effect has reached its maximum efficiency against the oxidation of said dietary aqueous liquid.

A white wine is considered to be under storage from the time when fermentation does not occur anymore and when all microorganisms present in the wine have been removed, through filtration for example. White wine is then stored in containers which may be, without limitation:
wineskins, or BIBS® (from anglicism bag-in-box), which are bags for wine housed within a carton and which gradually shrink as the bags are emptying without letting air enter thereinto;
glass bottles sealed with a closure, which may have a 75 cl capacity, carboy, demijohn, magnum, jeroboam, rehoboam, mathusalem, salmanazar, balthazar, nabuchodonosor, salomon, souverain or primat;
closed vessels (made of stainless steel, concrete, plastic, ceramics, and so on . . . );
cubitainers;
plastic bottles or brick packs (or Tetra-brik®));
containers made of oak wood which may be barrels, half-barrels, drums, casks or barils.

Preferably, the containers to store white wine are BIBs® or sealed glass bottles.

It is also an object of the invention to provide a method for stabilizing, during storage life, a liquid containing substances sensitive to oxidation, comprising a step of contacting the medium composed of said liquid to be stabilized with a stabilizing composition such as defined in the present invention.

Said method for stabilizing aims at fighting against the progressive oxidation of the liquid to be stabilized, throughout its storage life.

There are two different ways of contacting said yeast cell composition.

The selection between said two different contacting ways depends on the dissolved oxygen content of said liquid, which contains substances sensitive to oxygen.

If the oxygen content of said liquid is of at least 0.1 mg/L, for example in a younger wine prior to conditioning, it is important to divert oxygen to non-viable yeast cells capable to consume it rapidly in order to preserve the substances sensitive to oxygen, for example polyphenols. The totality of said liquid has therefore to be contacted with said yeast cell composition. In this embodiment, both types of yeast cells, (i) cells capable of consuming rapidly some oxygen and (ii) glutathione-enriched cells should be homogeneously distributed in said liquid, the contact surface between said liquid and said yeasts being then maximal.

If the dissolved oxygen content of the drink is very low, for example of at most 99 μg/L, as in the case for example of a wine during its storage over a long period of time, for example several months or even several years, in wine-making vats or in bottles or any other containers, oxygen dissolution should be avoided where the liquid is in contact with oxygen which might have entered into the container after its sealing, thus avoiding oxidation phenomena to occur at the interface between the liquid and the locations where oxygen may enter into the container. To that end, a maximum contact surface between oxygen and said yeasts should exist at said interlace. Thus, the distribution of said yeasts in said liquid should be targeted to said interfaces, for example that interface between the liquid and air entrapped on the surface thereof in a vat, or that interface between a wine and the inner surface of a wineskin. Various immobilization support forms for said yeasts may thus be contemplated, adapted to the various types of interfaces to occupy, for example immobilizing said yeasts on films in the case of vats, or alginate spaghettis suitably distributed on the inner surface in the case of wineskins or BIBs®.

Both preferred embodiments of said method are illustrated by means of semi-industrial tests performed on white wine which are described in example 5.

Advantageously, said stabilizing method is an alternative to sulfite (SO₂) addition in wines.

Indeed, contacting a wine with a composition comprising yeast cells according to the method of the invention advantageously allows, contrary to sulfite addition, to avoid the increased risk of allergies and does not cause any loss of the organoleptic quality. In addition, it is known that the presence of yeast dregs may induce, through cell lysis phenomena, the introduction of colloids that may improve the aromatic structure of wine.

In addition, some substances resulting from the lysis of the yeast cells do protect wine against potassium hydrogenotartrate and protein precipitations. Moreover, the cell walls of yeasts may absorb various unwanted substances, like fermentation products and heavy metals or toxins (ochratoxin A).

It should also be underlined the technical advantage given to the method of the invention by the use of inactivated yeast cells or non-viable yeast cells. Example 8 shows that even when included in an immobilization system, viable yeasts do multiply and are released in wine resulting in a significant increase in the wine turbidity and, as a consequence, in a substantial deterioration of its final quality. On the contrary, inactivated cells are not released in the medium and retain their capacity to consume oxygen and to preserve the compounds responsible for the wine organoleptic properties.

It is a further object of the present invention to provide a final white wine prepared according to said stabilizing method without any naked-eye detectable browning during the shelf-life thereof which has an oxydoreduction potential at most equal to the oxydoreduction potential prevailing at the time of its conditioning and concentrations of compounds impacting on the organoleptic properties of said wine at least equal to the concentrations of said compounds prevailing at the time of its conditioning.

The chromatic characteristics and the organoleptic properties of said final white wine are illustrated in the following examples hereunder.

Said final white wine is not oxidized during the shelf-life thereof by the fact that it has been contacted with the combination of the invention composed of two types of yeast cells. Indeed said yeast cells are capable of rapidly consuming oxygen of said white wine so as to prevent oxygen in a first stage from reacting with oxygen-sensitive compounds, some of which ensure the finished wine organoleptic properties, then in a second stage through the release of glutathione—a natural antioxidant—the said yeast are capable of preventing, during a long time, the cascade of oxidation reactions, thus prevents the formation of compounds which impair the organoleptic properties which are, for example, lightness, fruitiness, taste, flavors and appearance.

Oxidation of white wines in the long term is expressed through a naked-eye detectable browning and can be measured using the CIE color space 1976.

CIE color space 1976 is well known from the person skilled in the art. (According to Wikipedia) CIE Lab is a presentation model of colors developed by the International Committee on Illumination (Commission Internationale de Éclairage-CIE), in 1976. Combination L is the luminance, ranging from 0 (black) to 100% (white). Component a represents the red (positive value) to green (negative value) axis range including white (0) if luminance is 100%. Component b represents the yellow (positive value) to blue (negative value) axis range including white (0) if luminance is 100%. The Lb color model was defined as an absolute model, independent from the material, which may be used as a theoretical reference. It should be kept in mind for this model that it is by definition properly parameterized. There is thus no need for model-based, specific colorimetric spaces. In the practice however, this model is adapted to peripherals and printing supports (Adobe 1998, sRGB, ColorMatch, Pantone, etc.). CIE 1976 L*a*b* is directly based on the CIE XYZ diagram and aims at equalizing the perception amongst color differences. Non linear relationships for L*, a* and b* are intended to mimic the eye logarithmic response (in space L*a*b the eye detects 1 variation point of a or b for 5 points of L). Color data do refer to the chromaticity required as compared to the white point of the system.

An increase in parameter “a” can be observed, which turns the green tinge toward the red tinge, for oxidized white wines, see example b in semi-industrial tests. Such increase in parameter “a” could not be observed for final white wine according to the invention.

Lastly the present invention also relates to the use of the composition comprising two types of yeast cells according to the invention for protecting a dietary aqueous liquid, which contains substances sensitive to oxygen against the oxidation effects of said substances throughout the shelf-life thereof.

In the case of finished wines stored in wineskin, or BIB®, it is well known that even if the BIB® is provided with a tight plug, the conditioning occurs in the presence of a substantial headspace filled with air and the outer film of the wine bag is a film partially pervious to oxygen. BIBs® thus have poorer gas tightness properties as compared to glass bottles, (see ICV report, Institut coopératif du vin and du Conseil interprofessionnel des vins du Languedoc, “Conditionnement en caisses-outres (BIB®)”, ed 2006). Traditionally, wine is added with sulfite (SO₂), an oxygen-reducing chemical compound. Sulfites have drawbacks such as to be potentially allergenic, to be used in little amount, and to impart in high concentrations a “negative” sulphur odor.

The use of the composition of the invention offers many advantages as compared to the use of sulfite (SO₂) for protecting white wine against oxidation phenomena. Indeed yeasts in said composition are not viable or are inactivated, that is to say, they are unable to multiply and to ferment. There is no contamination risk or turbidity risk for the wine during the shelf-life thereof. They comply with the food standards since they are derived from the fermentation of said wine. The efficiency of the combination of yeast cells capable of rapidly consuming oxygen with glutathione-enriched yeast cells in preserving the quality of said white wine in BIBS® is illustrated in the following examples hereunder.

The composition, the method and the use according to the invention are illustrated by examples in the white wine preservation field. However, these examples may extend to other types of dietary aqueous liquids containing substances sensitive to oxygen. For example, yeast dregs resulting from the fermentation of rosé wines and red wines particularly sensitive to oxidation may also be used for protecting from oxidation said rosé and red wines. Beer fermentation yeasts made non viable and capable of consuming oxygen or inactivated and enriched with glutathione may protect beer against oxidation during the shelf-life thereof.

The fact that any species of yeast cells approved for human consumption may be rendered non viable and capable of rapidly consuming oxygen or may be inactivated and enriched with glutathione, makes the composition, the method and the use according to the invention applicable to stabilize any type of dietary aqueous liquid, containing substances sensitive to oxidation, during the shelf-life thereof.

The following examples describe, in detail, various aspects of the present invention.

### EXAMPLE 1

### Measurement of the Yeast Dreg-Mediated Oxygen Consumption

A. Material and Methods

A.1. Biological Material

1. Saccharomyces cerevisiae labeled yeast strain K1

Saccharomyces cerevisiae labeled yeast strain K1 was selected by ICV and INRA Montpellier and is produced, dried and conditioned by the Lallemand company. This strain was used for all experiments.

It comes in the form of active dried yeasts (LSA). Not requiring any previous culture prior to being used, these active dried yeasts are beforehand rehydrated: 1 g of these active dried yeasts are suspended in 10 mL glucose supplemented water at 50 g/L, allowed to warm to 37° C. This suspension is placed in a water bath at 37° C. for 30 minutes with a homogenization every 10 minutes. The culture medium is then inoculated with the rehydrated yeast preparation. The seeding rate is of 5 grams per hectoliter, i.e. 500 μL of the rehydrated yeast suspension in 1 L of culture medium.

2. OptiWHITE® Yeast

OptiWHITE® is an inactivated enological yeast, selected and prepared specifically for ensuring a progressive release of compounds from the yeast walls as well as a high antioxidant potential (glutathione richness). These inactivated yeasts have been used in two ways:
under enological conditions: i.e. 30 g/hL at the beginning or after the end of the alcoholic fermentation
in solution in a hydroalcoholic medium (CMP buffer described hereunder)

A.2. Culture Medium

The fermentation medium used is a synthetic medium called MS300, which reproduces the grape must average composition. It thus enables working under standard conditions while ignoring variations in composition observed with natural grape musts.

The MS 300 medium comprises all aminoacids, vitamins and growth factors required for a good development of strain K1 in anaerobiosis (Bely, 1990; Salmon and al., 2003). The assimilable nitrogen amount is of about 312 mg L⁻¹.

A.3. Analysis Media

i. CMP Buffer

This medium is a hydroalcoholic medium which pH corresponds to that of wine. It comprises:
Citric acid: 31 mM
D,L-Malic acid: 45 mM
KH₂PO₄: 10 mM
Ethanol: 11.8% (v/v)

The pH value is adjusted to 3.3 using KOH potash (10N)

ii. Phthalate Buffer

This medium had been considered by (Formairon-Bonnefond, 2000) as the most appropriate medium for analyzing the oxygen consumption rates. It is a 0.1 M phthalate solution adjusted to pH 4.5.

iii. White Wine Villaray

This wine is a dry white wine conditioned by Vinobag®. Its pH value is 3.3 and it comprises 11% of ethanol (v/v). It is contained in 3 liter- or 5 liter-capacity BIBs®, re-conditioned in laboratory in glass bottles set under argon atmosphere.

A.4 Technoloqical Implementation of Dregs

Various solutions have been proposed: dregs may be comprised (“entrapped”) in membrane capillaries and tubes or alginate beads.

1. Capillaries and Tubes

The membranes used are the following ones:
Microfiltration membrane CAPFIL MF02 M2 (X-Flow, Enschede, Netherlands)
Microfiltration membrane MD200 CV2N (Microdyn-Nadir, Wiesbaden, Germany)
Silicone tube Tygon® R-3603 (Saint-Gobain, Akron, United-States)

TABLE 1
characteristics of capillaries and tubes

| | MF02 M2 | MD200 CV2N | R-3603 |
|---|---|---|---|
| Composition | Polyether- | Polypropylene | Silicone |
| | sulfone & | | |
| | polyvinyl- | | |
| | pyrrolidone | | |
| Hydrophilic character | relatively | Hydrophobic | Hydrophilic |
| | hydrophilic | | |
| Outside diameter (m) | 2.5 · 10⁻³ | 2.5 · 10⁻³ | 2.38 · 10⁻³ |
| Inside diameter (m) | 1.5 · 10⁻³ | 1.6 · 10⁻³ | 3.97 · 10⁻³ |
| Pore maximum | 0.2 · 10⁻⁶ | | |
| diameter (m) | | | |
| Pore mean diameter (m) | 0.09 · 10⁻⁶ | | |
| Pore absolute size (m) | | 0.2 · 10⁻⁶ | |
| RhO(10⁻¹¹ m⁻¹) | 0.98 ± 0.14 | 1.16 ± 0.21 | |
| Specific surface (m²/g) | 10.63 | 15.54 | |

2. Alginate Beads

A mixture of a 3% sodium alginate solution (p/v) with the solution containing the cells to be immobilized is poured dropwise using a peristaltic pump in a calcium chloride solution (0.15 M). The amount of immobilized cells will be indicated for each experiment.

Oxygenation of the Samples

Most of the time, samples have been oxygenated to saturation with air oxygen. The samples are stirred manually for one minute.

A.5. Analysis Methods

1. Cell Counting

The evaluation of the yeast biomass is effected through cell count using an electronic particle counter Multisizer™ 3 Coulter Counter® (Beckman-Coulter, Roissy, France). Beforehand, the sample to be tested is diluted with an automatic diluter Microlab 500 (Hamilton, Bonaduz, Suisse) using an isotonic counting solution Isoton (Beckman-Coulter, Roissy, France) in order to have 4 000 to 80 000 cells per mL in the diluted sample which will be counted at the end. The diluted sample is submitted to ultrasounds for 30 seconds on generator Sonifier® S250A (Branson, Danbury, United-States) in order to separate the optionally formed aggregates. Finally cell counting is performed on the particle counter.
2. Dry Weight

Three ×10 mL of a sample are filtered under vacuum through a 0.22 μm filter that has been beforehand dried and tarred. The filter cell cake recovered with the membrane is dried in an oven at 108° C. for 24 hours. The samples are then weighted.

A.6. Oxygen Consumption Rate
1. Oroboros® Oygraph-2k

For measuring the oxygen consumption rates of the samples, an Oxygraph-2k (Oroboros® Instruments, Innsbruck, Austria) was used. This high-resolution device comprises two parallel chambers enabling the testing of two samples under the same conditions.

The characteristics of the device are as follows:
Outer shell of the chambers in stainless steel and temperature regulation through Peltier effect→very accurate temperature regulation.
   Reaction volume: 2 mL
   Data recording every 2 seconds
   Chambers in glass, plugs and filling tubes in titanium→leakage and oxygen diffusion minimization
   Stirring monitoring
   Polarographic oxygen sensors: Orbisphère® sensor high sensitivity

Oxygen sensors are inserted on the side, transversally to the glass chamber. Oxygen diffuses from the sample to the surface of the cathode through a non stirred sample layer which is located on the outer side of the membrane, then goes through the membrane and finally through the electrolyte layer. For minimizing this non stirred sample layer, it is necessary to continuously and vigorously stir the sample: 750 rpm under specified conditions.

The characteristics of the Orbisphère sensor model 2120 are as follows:
A cathode in gold with a relatively large surface (2 mm diameter) to obtain a high sensitivity and at constant zero
An anode in silver/silver chloride, which surface is larger than that of the cathode
A potassium chloride electrolyte (KCl 1 M)
A 0.25 μm-thick FEP membrane (fluorinated ethylene-propylene)
A 0.8 V bias voltage

2. Oxi 197S

In order to determine the evolution of oxygen concentration as a function of time and the total maximum amount of oxygen consumption, an oximeter OXI 197S (WTW, Weilheim, Germany) fitted with a Clark electrode was used to measure oxygen concentration in the samples.

The sensor used is a CellOx 325 (WTW, Weilheim, Germany) which characteristics are as follows:
A working gold electrode
A lead counter electrode
An electrolyte
A 3 μm-thick FEP membrane (fluorinated ethylene-propylene)

The measurement of the yeast dreg-mediated oxygen consumption is performed in a vial that is thermally regulated through water circulating in its double-jacket wall. A magnetic stirrer homogenizes the reaction medium during measurement. Data are recorded every 3 seconds. Once the air is saturated with oxygen through manual stirring (vigorously) of the solution to be measured, oxygen concentration measurement is started in the tightly sealed flask until a plateau is reached. Thereafter the solution is re-oxygenated in air, the flask is sealed again and measurement is started, and so on. The consumed oxygen total amount is determined based on the data that are collected to perform a cumulative analysis.

A.7 Measurement of the Oxygen Concentration as a Function of Time

Each sample (wine alone and resuspended dreg-containing wine) is brought to air oxygen saturation through stirring and distributed in 70 mL-capacity tight flasks. The flasks are all maintained at 30° C. and the dreg-containing samples are either homogenized using a magnetic stirrer, or are not submitted to stirring. Curves obtained from the various measurements are smoothed with the Sigmaplot® software (SPSS inc., Richmond, United-States). The oxygen consumption rate is obtained by calculating the derivative of the smoothed curve.

B. Results

The results of Table 2 hereunder enable to follow the evolution of the oxygen consumption rate measured at 30° C. as a function of the cell titration of yeast dregs resuspended in a CMP buffer (hydroalcoholic medium pH 3.3, 11.8% (v/v) ethanol). Averages and standard deviations for 4 measurements are given in Table 2.

TABLE 2

| Cell concentration | Oxygen consumption rate | Standard deviation |
|---|---|---|
| (10⁶ cells mL⁻¹) | (ng O₂ s⁻¹ mL⁻¹) | (ng O₂ s⁻¹ mL⁻¹) |
| 0.0 | 0.15 | 0.015 |
| 33.6 | 0.08 | 0.010 |
| 115.2 | 0.18 | 0.026 |
| 374.0 | 0.37 | 0.005 |

It can be observed when measuring the yeast dreg-mediated oxygen consumption that in a first stage the consumption rate for a small cell concentration is lower than that of the buffer alone. It can be assumed that the measure obtained with the hydroalcoholic medium (CMP) with no yeast corresponds to the consumption of the electrode itself and that when dregs are added, this consumption becomes negligible because of the high affinity of the dregs for oxygen.

### EXAMPLE 2

### Comparing Oxygen Consumption of Various Types of Yeasts

A. Material and Methods:

Material and methods are the same as for example 1.

B. Results

The dreg-mediated oxygen consumption rates (that is to say by the yeasts K1 cultured in the fermentation medium MS300 reproducing the natural grape must conditions) have been measured by means of a high-resolution oximeter Oxygraph-2k (Oroboros® Instruments, Innsbruck, Austria) and have been compared with those of the dry active yeast K1 rehydrated according to the supplier's instructions (Lallemand SAS, Blagnac, France) and with that of the inactivated yeast OptiWhite which comprises glutathione (and/or other cysteinyl peptides). The results obtained are shown in Table 3 and confirm the benefit of dregs consuming oxygen dissolved in wine.

The results given in Table 3 illustrate the oxygen consumption measured at 30° C. as a function of dry weight, for dregs, LSA and inactivated yeasts OptiWhite® in a CMP buffer (hydroalcoholic medium pH 3.3, 11.8% (v/v) ethanol).

TABLE 3

| | Oxygen | | Oxygen | | Oxygen |
|---|---|---|---|---|---|
| Dreg | consumption | LSA | consumption | Optiwhite | consumption |
| weight | rate | weight | rate | weight | rate |
| (g) | (ng O₂ s⁻¹ mL⁻¹) | (g) | (ng O₂ s⁻¹ mL⁻¹) | (g) | (ng O₂ s⁻¹ mL⁻¹) |
| 0.0000 | 0.2590 | 0.0000 | 0.2590 | 0.0000 | 0.2590 |
| 0.0045 | 0.7636 | 0.0050 | 0.3192 | 0.00018 | 0.3199 |
| 0.0089 | 0.8946 | 0.0100 | 0.5713 | 0.0016 | 0.2842 |
| | | | | 0.0083 | 0.2572 |
| | | | | 0.0142 | 0.3316 |

Inactivated yeasts OptiWhite® do not seem to consume oxygen. This could be due to the inactivation method used which could affect the membrane (or sterols in the membrane) and the cells therefore could not consume oxygen anymore. However these yeasts actually contain glutathione (3 to 4 times more than dregs) and remain thus interesting as regards the flavor protection (especially the volatile thiols). Indeed, in the literature, the protecting effect of dregs for the evolution of wines has been explained with a different approach (Dubourdieu and al., 2002; Lavigne-Cruége & Dubourdieu, 2004). Glutathione (or other aminoacids or sulfur-containing peptides) could protect sulfur-containing flavors from their deterioration by forming disulfide bridges.

### EXAMPLE 3

### Glutathione Release Kinetics from Inactivated Yeasts Enriched with Glutathione

A. Material and Methods.

A.1. Products Under Test.

Two products corresponding to yeasts enriched with glutathione have been tested:
Product SI (product from Lesaffre)
Product OW (product from Lallemand)

A.2 Release Kinetics.

0.5 g by dry weight of each of the tested products were solubilized in 30 mL of a wine-simulating medium which contains (per liter): citric acid: 6 g; DL-malic acid: 6 g; KH₂PO₄: 750 mg; K₂SO₄: 500 mg; MgSO₄, 7H₂O: 250 mg; CaCl₂, 2H₂O: 155 mg; NaCl: 200 mg; and ethanol, 120 mL. Medium is buffered at pH 3.3 by adding KOH 10N.

The release kinetics was measured for 10 hours at 28° C. under stirring. Samples (1 mL) have been collected, then centrifuged at 14000×g for 5 minutes. The supernatant was deproteinized by a volume to volume treatment using 5% sulfosalicylic acid and by centrifugation at 14000×g for 5 minutes. As a result the sample is diluted x2.

A.3 Analyzing the Glutathione Released.

Released glutathione assay was performed using the glutathione assay kit marketed by the Sigma company (art. ref.: CS0260-1 KT). This kit assays all the glutathione reduced and oxidized forms. A standard range of reduced glutathione ranging from 0 to 25 μM is used for calibrating the kit.

B. Results

The results of the tested samples are as follows:

TABLE 4
glutathione release kinetics

| | Collecting time | [GSH] in 10 μl pure |
|---|---|---|
| Samples | (hours) | sample (μM) |
| SI | 0 | 2.0 |
| SI | 1 | 242.0 |
| SI | 3 | 228.0 |
| SI | 5 | 234.0 |
| SI | 5 | 216.0 |
| SI | 10 | 230.0 |
| OW | 0 | 2.0 |
| OW | 1 | 284.0 |
| OW | 3 | 298.0 |
| OW | 5 | 256.0 |
| OW | 5 | 240.0 |
| OW | 10 | 242.0 |

Both products SI and OW released glutathione in the medium in a quick and quasi-similar way to reach a concentration of about 250 μM when resuspended at a concentration of 16.7 g (d.w.) L⁻¹.

As regards the glutathione content in the products tested, following values could be calculated:

TABLE 5
Glutathione content

| | GSH content |
|---|---|
| Product | (mg/g (d.w.)) |
| SI | 4.5 |
| OW | 5.5 |

### EXAMPLE 4

### Evaluation of the Synergistic Effect of the Combination of Two Types of Yeast Cells, Respectively (i) Non-Viable Yeast Cells Capable of Rapidly Consuming Oxygen and (ii) Inactivated Yeast Cells Enriched with Glutathione, on The Preservation of a Dietary Aqueous Liquid Sensitive to Oxidation, Here a White Wine

A. Material and Methods

Four categories have been defined (see table 6 hereunder) with 5 replications i.e. 5 flasks de 50 mL per category.

TABLE 6
compared categories

| Category | Code |
|---|---|
| Control | T |
| Fresh dregs alone | L |
| Optiwhite ® alone | OW |
| Fresh dregs + Optiwhite ® | L + OW |

A.1. Preparation:
Dregs: total of cells=4.3.10¹¹ fractionated in 2×5=10 flasks i.e. 4.3.10¹⁰ cells for 50 mL or 8.6.10¹¹ cells/liter.
OW: 250 mg fractionated in 5 flasks i.e. 50 mg/flask or 1 g/L.
Alginate: 1500 mg fractionated in 5 flasks i.e. 300 mg/flask or 6 g/L.

Except the control flasks, all flasks contained 6 g of alginate beads.

A.2. Wine Used

A white wine Sauvignon from Gers, elaborated by us in an experimental wine cellar of INRA-Pech Rouge was used. This wine, very sensitive to oxidation, has strong aromatic tasting note due to a large amount of varietal sulfur thiols. At the beginning of the experiment, this wine has a concentration of free SO₂ of 15 mg/L

A.3. Measurements of the Dissolved Oxygen

We used the PRESENS fluorescence-based system, model Fibox3 Trace-V3. Two reference dots SB3 of about 5 mm diameter are stuck inside 2 flasks per category (i.e. a total of 8 flasks and 16 dots). Two other dots are stuck on a bottle filled with water. The oxygen measurement is directly carried out using an optical fiber through the glass. We did not calibrate the device beforehand, but we did record every day the dissolved oxygen value in the saturated water bottle and did check that this value did correspond to the theoretical values given in the tables.

A.4. Luminosity and Color Measurements

Color is measured by means of a MINOLTA chromameter fitted with a SPR200 sensor for solid objects, directly indicating L, a and b (CIE 1976). The sensor is applied to the flask, a white plate is applied to the other side with the side contacting the glass and the measurement is carried out. We did not calibrate the device beforehand, but a reference was made on each white plate before and after each series of measurements and we did check that this reference was stable over time.

A.5. Aromatic Compounds

The analysis was performed by Laurent DAGAN(NYSEOS SARL, Montpellier, France).

B. Results

B.1. Dissolved Oxygen

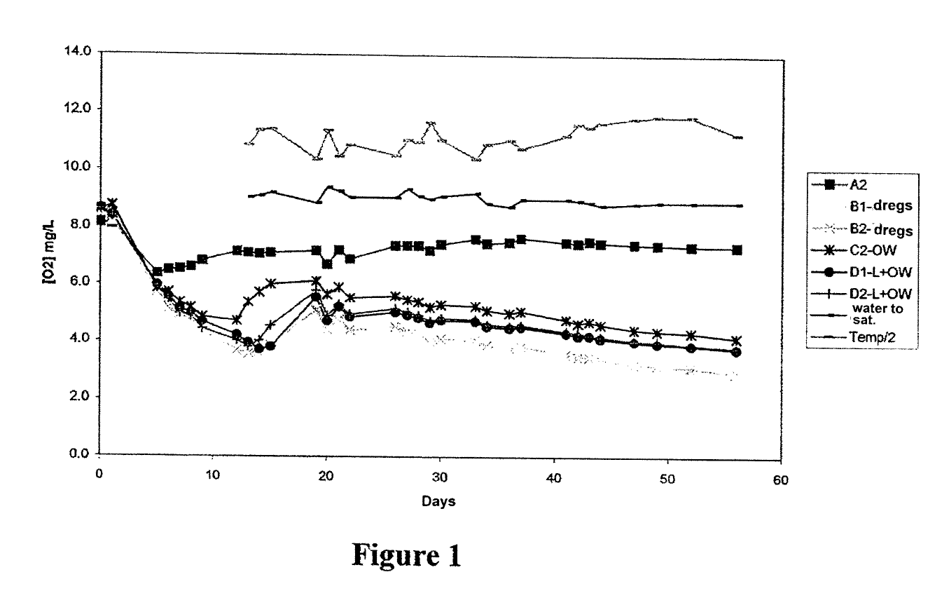

The results of the measurements for evaluating the dissolved oxygen amount during storage are illustrated on FIG. 1.

During the two month-storage at room temperature, the Control flask (without treatment) has a dissolved oxygen content clearly higher than the three other categories. An interference occurring in all treated flasks appears between day 15 and day 20 of the treatment, but from that moment and up to the end of the test, the oxygen content in categories Dregs, OW and Dregs+OW slowly and continuously decreases without intermission.

As regards the interference observed in the treated flasks, it may be suggested the following explanation: during the first 14 days, dregs and OW contained in the three categories Dregs, OW and Dregs+OW do rapidly consume the oxygen that is present in the wine, which explains the observed quick decrease of oxygen voltage. This quick oxygen consumption capacity seems to decelerate from day 14, and dissolved oxygen increases again in these three categories. An equilibrium between the consumed oxygen and the oxygen entering the flasks at the screw caps is then established.

With more than 4 mg/L, the dissolved oxygen amounts after 50 days are very high and illustrate that a very high oxidation capacity remains in wine in all categories.

B.2. Luminosity and Color.

The results of the measurements for each parameter “L”, “a” and “b” are given in Table 7 hereunder.

TABLE 7
Measurement of parameters L, a and b during the shelf-life

| Time | Control | | | Dregs | | | OW | | | Dregs + OW | | |
|---|---|---|---|---|---|---|---|---|---|---|---|---|
| (days) | L | a | b | L | a | b | L | a | b | L | a | b |
| 0 | 35.40 | −0.37 | 5.10 | 35.39 | −0.39 | 5.07 | 35.45 | −0.44 | 5.11 | 34.80 | −0.31 | 5.01 |
| 5 | 35.47 | 0.26 | 5.46 | 33.60 | 0.23 | 4.02 | 36.45 | 0.18 | 5.27 | 35.55 | 0.23 | 4.93 |
| 8 | 35.94 | 0.50 | 5.30 | 36.31 | 0.24 | 4.65 | 36.55 | 0.21 | 4.90 | 35.25 | 0.33 | 4.60 |
| 12 | 35.51 | 0.67 | 5.03 | 37.10 | −0.23 | 4.41 | 35.67 | −0.05 | 4.43 | 36.26 | 0.15 | 4.65 |
| 15 | 35.67 | 0.75 | 5.19 | 36.64 | −0.51 | 4.16 | 36.20 | −0.18 | 4.61 | 36.84 | −0.30 | 4.73 |
| 19 | 35.41 | 0.79 | 5.27 | 36.85 | −0.70 | 4.03 | 36.27 | −0.20 | 4.65 | 37.02 | −0.70 | 4.22 |
| 22 | 35.46 | 0.93 | 5.21 | 37.59 | −0.75 | 4.06 | 36.51 | −0.19 | 4.61 | 37.41 | −0.78 | 4.21 |
| 26 | 34.77 | 0.91 | 4.97 | 37.57 | −0.82 | 3.94 | 36.46 | −0.22 | 4.56 | 37.55 | −0.83 | 4.21 |
| 29 | 35.07 | 1.03 | 5.32 | 37.36 | −0.62 | 4.16 | 35.67 | −0.01 | 4.42 | 36.46 | −0.60 | 4.01 |
| 33 | 35.25 | 1.12 | 5.22 | 37.07 | −0.59 | 3.92 | 36.10 | 0.02 | 4.57 | 37.60 | −0.70 | 4.20 |
| 37 | 35.05 | 1.18 | 5.19 | 37.55 | −0.57 | 4.29 | 36.23 | 0.01 | 4.88 | 36.70 | −0.52 | 4.13 |
| 41 | 35.42 | 1.19 | 5.65 | 37.03 | −0.49 | 4.19 | 35.61 | 0.10 | 4.64 | 37.20 | −0.53 | 4.32 |
| 44 | 34.96 | 1.16 | 5.45 | 36.73 | −0.49 | 4.46 | 35.66 | 0.12 | 4.82 | 36.55 | −0.49 | 4.27 |
| 47 | 35.43 | 1.15 | 5.89 | 37.17 | −0.50 | 4.40 | 36.05 | 0.11 | 5.02 | 36.72 | −0.48 | 4.28 |
| 50 | 34.92 | 1.19 | 5.69 | 37.38 | −0.42 | 4.57 | 35.37 | 0.25 | 4.84 | 37.20 | −0.41 | 4.56 |
| 54 | 34.64 | 1.17 | 5.84 | 36.49 | −0.40 | 4.36 | 36.07 | 0.12 | 5.34 | 36.23 | −0.36 | 4.39 |

Evolution of the chromatic parameter “L”.

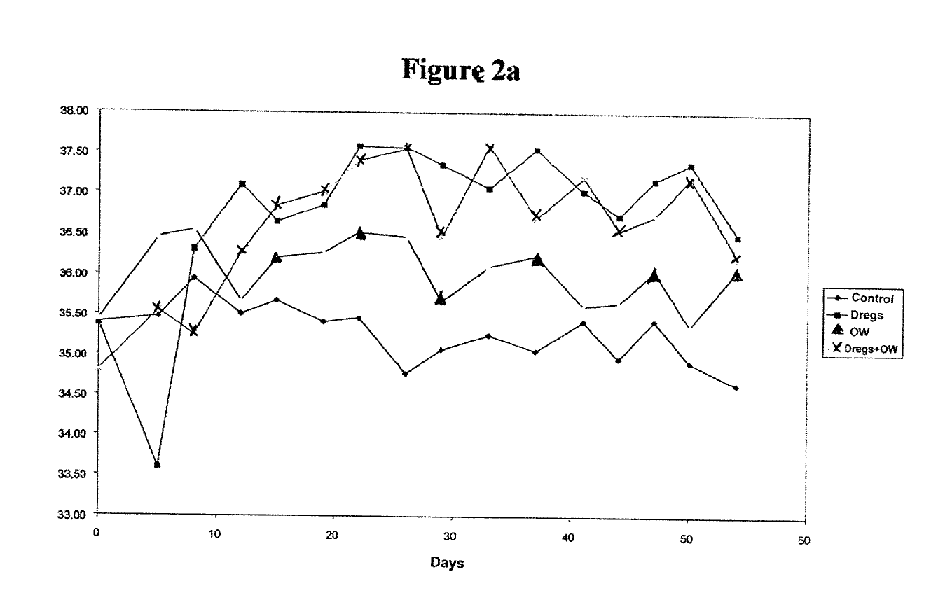

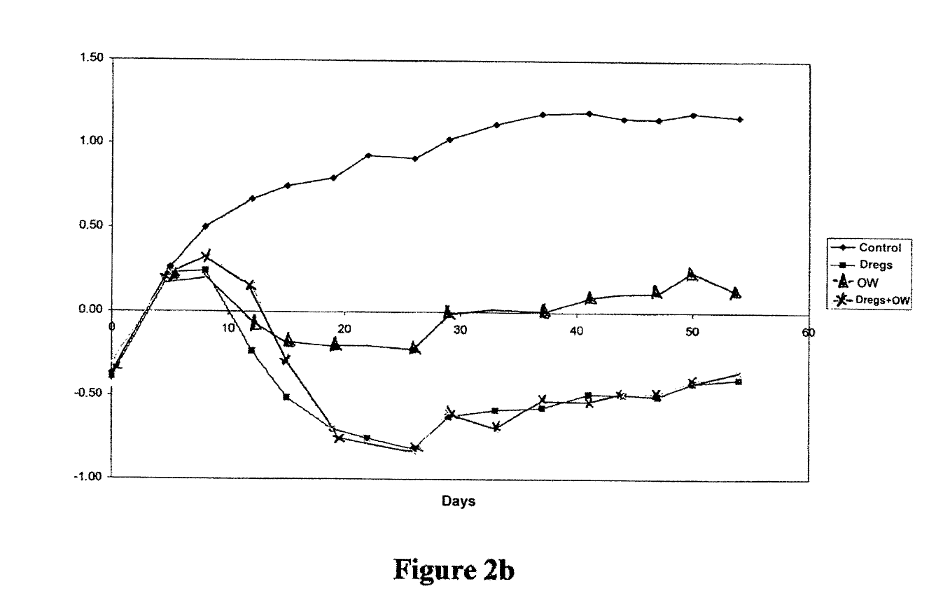

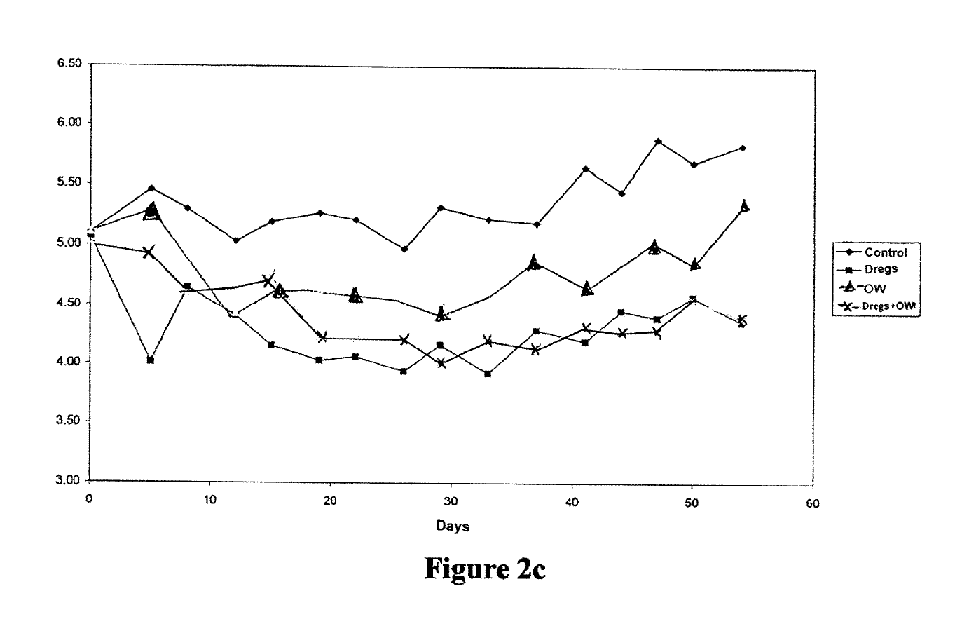

The results are also illustrated on FIG. 2a. The luminosity corresponds to the white light intensity in the wine color. The higher “L” is, the clearer the sample. “L” does range from 0 to 100.

The evolution during shelf-life is first chaotic, then the sample luminosity stabilizes after 2 weeks and categories are always sized in the same increasing luminosity order:

Control<OW<Dregs=Dregs+OW
Evolution of the chromatic parameter “a”. The results are also illustrated on FIG. 2b.

“a” turns from green to red. In wines, the increase in “a” corresponds to an oxidative evolution of the color.

Parameter “a” increases from the first week of storage. Thereafter there is a very clear difference between the “Control” flasks for which parameter “a” keeps increasing, and the three other categories for which this parameter clearly decreases between day 7 and days 20-25 prior to slowly re-increasing again, at the same rate as the Control.

At the end of the test, the 4 categories are clearly differentiated.

Depending on an increasing “a”: Dregs=Dregs+OW<OW<Control
Evolution of chromatic parameter “b”. The results are also illustrated on FIG. 2c.

Parameter “b” is a measure of the blue values (negative values) or of the yellow values (positive values) of the wine color.

Chromatic parameter “b” has a low but significant evolution over time. From weeks 2 to 3, the 4 categories are thus discriminated, depending on an increasing parameter “b”:

Dregs=Dregs+OW<OW<Control

B.3. Aromatic Compounds

3-mercapto-hexanol (3 MH) and its acetate salt (3 MHA) are two molecules typically representative of the white Sauvignon variety specific flavors. These two molecules comprise a thiol function and therefore are particularly sensitive to oxidation. The content measurement results for both compounds after a storage of 60 days are given in Table 8 hereunder.

TABLE 8

| | 3-Mercapto- | 3-Mercapto- |
|---|---|---|
| | Hexanol | Hexanol acetate |
| | (ng/L) | (ng/L) |
| Dregs | 403 | 221 |
| OW | 892 | 256 |
| Dregs + OW | 945 | 379 |
| Human olfactory perception | 60 | 8 |
| threshold | | |

The varietal thiol loss is higher for category dregs, and lower for categories Dregs+OW and OW.

The concentration evolution is consistent for the three categories having received alginate beads. OW would be more efficient than dregs alone, the protecting effects of the thiols being cumulative for category Dregs+OW.

Control<Dregs<OW<Dregs+OW

B.4. Sensory Analysis.

Samples have been tasted at the end of the analysis, on 24th of May 2007, by two enologists: enologists O1 and O2.
Comments enologist O1.

The wines with the most intense flavors are categories Dregs and Dregs+OW in a similar degree, OW is the less intense.
Comments enologist O2.

Very different colors:
Control=yellow turning maroon/pinkish
Dregs=yellow/very little pinkish
OW=yellow/little pinkish
Dregs+OW=true yellow

Flavors:
Control=strong, half “thiol” component, half oxidation flavors
Dregs+OW=the finest: “thiol” flavors discreet but present, no oxidation flavors

Dregs and OW: intermediate

Finish:

Control=much heavier, oxidized

Dregs+OW=the most pleasant and optimally well-balanced for finish

Dregs and OW=intermediate

Conclusion:

Control<Dregs ═OW<Dregs+OW

No detectable yeast taste.

Finally, category Dregs+OW gives qualitatively the best wine according to 3 sensory descriptors: color, nose, wine's finish. The Control is undeniably the worst noted as regards its sensory properties.

Conclusions

All the flasks have been stored at more than 20° C. with dissolved oxygen amounts higher than 4 mg/L. These conditions are very favorable to oxidation phenomena.
D0 to D5.

The 4 categories have the same behavior: reduction of dissolved oxygen resulting from the wine or additives thereto (SO₂), increase in chromatic parameter “a” in the same extent.
D5 to D14.

For the 3 categories Dregs, OW and Dregs+OW, a reduction of chromatic parameter “a” is observed. Since there still remains much dissolved oxygen in all the flasks, this different evolution shows clearly that there is indeed an interaction resulting from alginate beads, because the polyphenol oxidation remains limited. On the contrary, thiols have been oxidized as illustrated through the flavor analyses.

On the contrary, in the Control, parameter “a” increases, which is an indication that the polyphenol oxidation continues. This causes a noticeable browning of the wine.

A stronger decline of dissolved oxygen is well observed in categories Dregs, OW and Dregs+OW. Alginate itself could have entrapped part of the oxygen, but in this event, this oxygen would have been consumed by dregs or OW; and it would not have subsequently rediffuse in wine. It is more likely that the O2 consumption capacity of dregs and OW has become null after 14 days because of a saturation of the systems involved.
D14 to D20.

Dissolved oxygen increases in the 3 categories: Dregs, OW, Dregs+OW. It is likely that this fact corresponds to the difference between oxygen penetration through the screw cap, and its consumption by wine, dregs and/or OW. This hypothesis is confirmed by the results for category Control, which reaches a stable amount of dissolved oxygen much higher than all other flasks, in the absence of any oxygen consuming system.
D20 to D25.

Dissolved oxygen stabilizes and starts decreasing again, steadily and at the same rate for every categories. From D5 to D25, chromatic parameter “a” still decreases and reaches its minimum value for categories Dregs, OW and Dregs+OW.
D25 to D54.

All categories follow the same evolution: moderate increase in chromatic parameter “a” and moderate decrease in dissolved oxygen.

To conclude, even a negative effect on the 3 MH concentrations and ester thereof, categories with Dregs, OW and above all Dregs+OW give a wine that is qualitatively better than the Control. This result shows all the benefit of this approach and the possibilities thus offered for protecting both color and flavors of the volatile thiol type.

As regards the synergistic or antagonistic aspects of both implemented antioxidant systems, by using a rating scale from 1 (less efficient) to 3 (very efficient), the following summary table 9 may be created:

TABLE 9

| Tested characters | Control | Dregs | OW | Dregs + OW |
|---|---|---|---|---|
| Oxygen consumption | 1 | 3 | 2 | 2 |
| Increase in | 1 | 3 | 2 | 3 |
| parameter “L” | | | | |
| Decrease in | 1 | 3 | 2 | 3 |
| parameter “a” | | | | |
| Decrease in | 1 | 3 | 2 | 3 |
| parameter “b” | | | | |
| Preservation of | 1 | 2 | 3 | 3 |
| varietal thiols | | | | |
| Organoleptic score | 1 | 2 | 2 | 3 |
| Global score = | 6/18 | 6/18 | 13/18 | 17/18 |
| sum of scores | | | | |

The antioxidant effect provided by the two antioxidant systems implemented is therefore not just a simple juxtaposition of the antioxidant effects of both systems considered separately. They complement each other in their respective actions and provide to the wine an efficient protection against oxidation phenomena during its shelf-life, whether in terms of color, of preservation of the varietal flavors sensitive to oxidation, or more generally speaking in terms of organoleptic quality.

### EXAMPLE 5

### Semi-Industrial Tests Conducted on White Wine: Tests on Wine in Canisters

A. Material and Methods

Villaray white wine that has been beforehand saturated with oxygen was conditioned in a glass canister tightly sealed under argon and fitted with a Teflon-lined Sovirel cap.

Alginate beads containing both yeast dregs K1 (yeasts capable of rapidly consuming oxygen) at an equivalent final concentration of 2.3 10⁶ cells/mL and Optiwhite® inactivated yeasts (dead yeasts releasing glutathione) at an equivalent final concentration of 0.35 mg/ml have been introduced into canister batches called “tests”, while the other canister batches called “controls” remained free of beads.

Canisters have been stored for 15 days at room temperature (simulation of wine aging conditions), then sacrificed over time to measure: 1) the residual dissolved oxygen content, 2) the oxydoreduction potential of wine, 3) the glutathione content in wine, and 4) the chromatic characteristics of wine.

B. Results

Measurements (i) of the dissolved oxygen content, (ii) of the oxydoreduction potential and (iii) of the glutathione content of the wine have been performed. The results are given in Table 10 hereunder.

TABLE 10
measures of dissolved oxygen

| | Control | | | Test | | |
|---|---|---|---|---|---|---|
| | Dissolved | Redox | | Dissolved | Redox | |
| Time | oxygen | potential | Glutathione | oxygen | potential | Glutathione |
| (Days) | (mg/L) | (mV) | (mg/L) | (mg/L) | (mV) | mg/L) |
| 0 | 7.1 | 191 | 0.39 | 7.1 | 191 | 0.39 |
| 1.8 | 3.7 | 185 | — | 2.4 | 155 | |
| 2.8 | 2.53 | 177 | 0.39 | 1.5 | 130 | 20.8 |
| 3.8 | 2.2 | 185 | 0.38 | 0.98 | 129 | 20.1 |
| 4.8 | 1.87 | 187 | 0.47 | 0.21 | 105 | 17.0 |
| 5.8 | 2 | 186 | 0.48 | 0.24 | 91 | 16.3 |
| 11.7 | 0 | 168 | 0.49 | 0 | 68 | 14.1 |

5.1. Residual Dissolved Oxygen Content

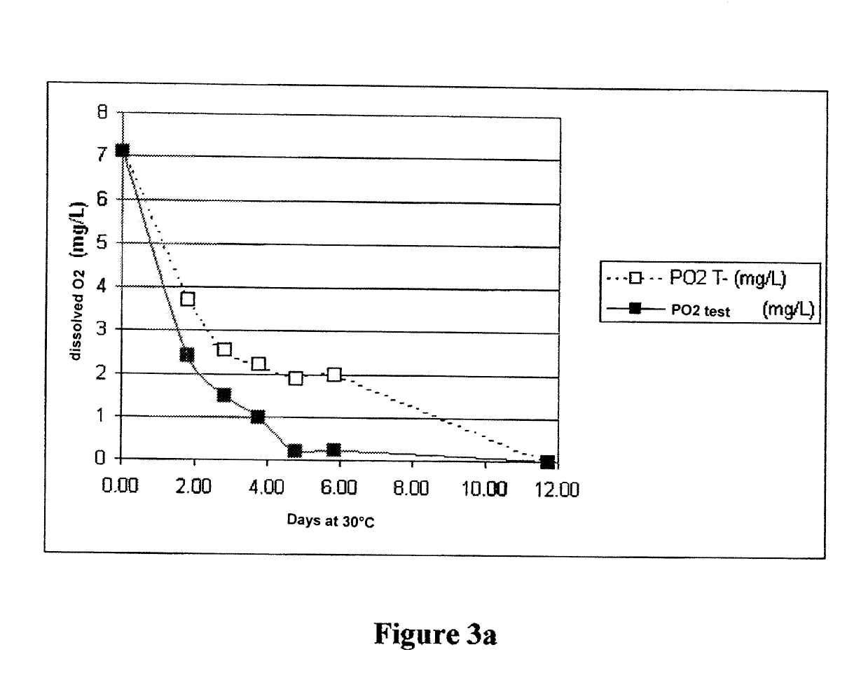

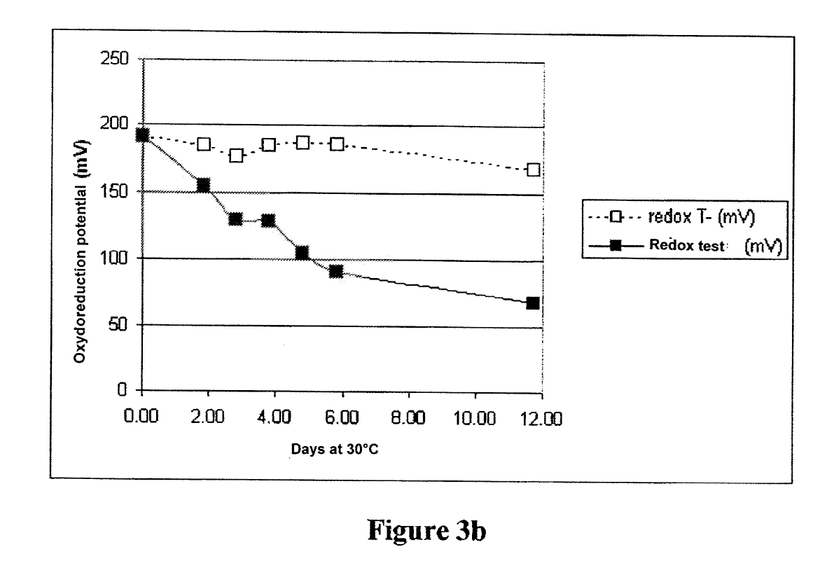

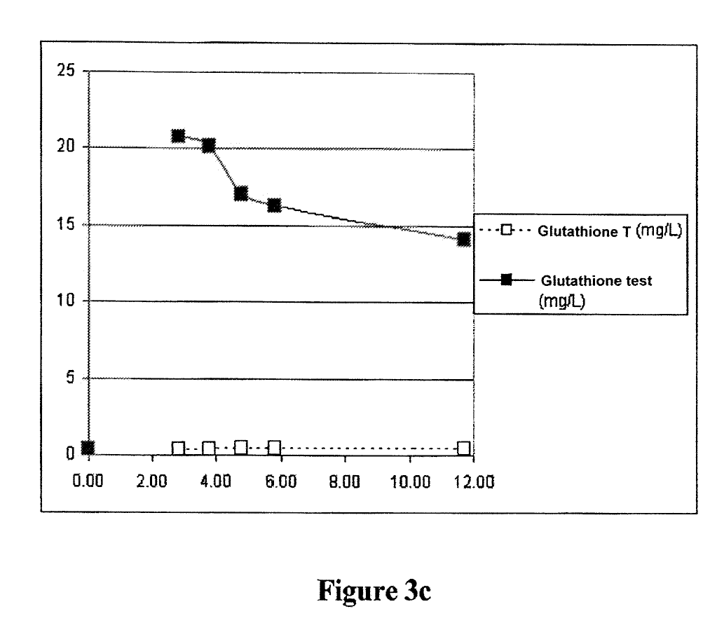

The results of the residual dissolved oxygen measurements are given in Table 10 hereabove as well as on FIG. 3a.

5.2 Oxvdoreduction Potential

The results of the oxydoreduction potential measurements are given in Table 10 hereabove as well as on FIG. 3b

5.3 Glutathione Content in the Wine

The results of the glutathione content measurements are given in Table 10 hereabove as well as on FIG. 3c.

5.4. Chromatic Characteristics of the Wine

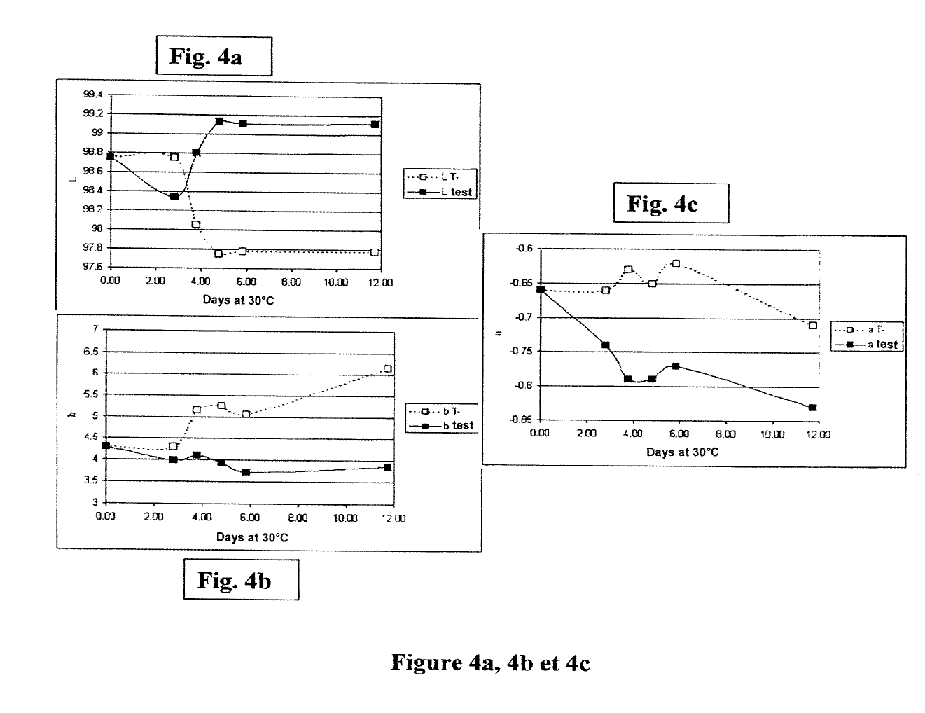

The results of the chromatic characteristic measurements of the wine are given in Table 11 hereunder as well as on FIGS. 4a (parameter “L”), 4b (parameter “a”) and 4c (parameter “b”).

TABLE 11

| | | |
|---|---|---|
| Time | Control | Test |

| (Days) | L | a | b | L | a | |
|---|---|---|---|---|---|---|
| 0 | 98.75 | −0.66 | 4.29 | 98.75 | −0.66 | 4.29 |
| 2.8 | 98.75 | −0.66 | 4.29 | 98.34 | −0.74 | 3.98 |
| 3.8 | 98.05 | −0.63 | 5.15 | 98.8 | −0.79 | 4.1 |
| 4.8 | 97.75 | −0.65 | 5.26 | 99.13 | −0.79 | 3.93 |
| 5.8 | 97.78 | −0.62 | 5.06 | 99.111 | −0.77 | 3.72 |
| 11.7 | 97.78 | −0.71 | 6.15 | 99.12 | -0.83 | 3.85 |

The presence of alginate beads containing dregs and Optiwhite enables a much earlier and quicker decline of dissolved oxygen in wine. Considering the wine chromatic characteristics, this dreg-mediated oxygen consumption made it possible to preserve the wine polyphenolic components from a detrimental oxygen-mediated oxidation (preservation of parameters L and b*, corresponding respectively to lightness, and to the yellow color of wine). The glutathione release through the beads enabled to substantially reduce the oxydoreduction potential of wine, proof of a possible preservation of volatile compounds sensitive to oxidation (varietal thiols for example).

### EXAMPLE 6

### Semi-Industrial Tests Conducted on White Wine: Tests on Wine in BIBs®

A. Material and Methods

On a BIB® bottling line for Sauvignon white wine (Skalli SARL Fortant de France, Sete), alginate spaghettis containing yeast dregs K1 have been added prior to filling on the line at an equivalent concentration of 2.3 10⁶ cells/mL. 30 BIBs® of 3 liters have been conditioned, amongst which 15 batches “control” and 15 batches “test”. BIBS® are stored from the moment where they have been filled (May 10, 2006) at 21° C. Sampling is regularly carried out within a period ranging from 6 to 12 months.

B. Results

The results shown only relate to the first collected and analyzed samples.

Despite the very numerous differences in the initial contents between the control and test batches (due to the initial container handling: opening, manual introduction of the spaghettis), a very substantial decline in the oxygen content of the wine could be detected in the presence of dregs.

The results of the dissolved oxygen content measurements are given in Table 12 hereunder. Table 12 shows the evolution of the dissolved oxygen content for a wine stored in control BIBs® without contact with the composition of the invention.

TABLE 12

| | |
|---|---|
| Time | Dissolved oxygen (mg/L) |

| (Days) | Control 1 | Control 2 | Test 1 | Test 2 |
|---|---|---|---|---|
| 0.00 | | | | |
| 19.00 | 0.66 | 0.89 | 2.78 | 3.44 |
| 36.00 | 0.70 | 1.28 | 2.19 | 2.80 |
| 54.00 | 0.86 | 1.12 | 1.58 | 1.67 |

The results of chromatic characteristic measurements of wine are given in Table 13 hereunder. Table 13 shows the evolution of the chromatographic characteristics “L” and “b” of CIE 1976 for a wine stored in control BIBs® (“Control”), as well as the evolution of the chromatographic characteristics “L” and “b” of CIE 1976 for a wine stored in BIBS® having been contacted with the composition of the invention (“Test”). The results are given as a function of the number of days of shelf-life at 30° C.

TABLE 13

| Time | Control | | | | Test | | | |
|---|---|---|---|---|---|---|---|---|
| (Days) | L | b | L | b | L | b | L | b |
| 36.00 | 49.61 | 9.69 | 50.5 | 9.48 | 51.46 | 10.04 | 49.77 | 10.01 |
| 54.00 | 50.35 | 10.43 | 52.08 | 10.81 | 49.8 | 11.64 | 49.68 | 11.06 |

The wine chromatic parameters evolve towards a decrease in (or a preservation of) parameter L exposed to immobilized dregs (while the tendency is an increase in control batches). As in the previous test, a stronger increase in parameter b* could be observed in test batches, which results in a more pronounced yellow note in the wines.

### EXAMPLE 7

### Contact Surfaces Between Glutathione-Enriched Yeasts and Dissolved Oxygen

Examples of contact surfaces between yeast cells and dissolved oxygen are given hereunder, as an illustration:

Example: 2.3 10⁹ yeasts/L and 350 mg/L of Opti-White (1.17 10¹⁰ cells/L)

Example: 8.6 10¹¹ yeasts/L and 1 g/L of Opti-White (3.33 10¹⁰ cells/L).

A yeast for use in a wine-making process has an average equivalent area of about 80 μm² (SALMON, 1997-Enological fermentation kinetics of an isogenic ploidy series derived from an industrial Saccharomyces cerevisiae strain. Daynal of Fermentation and Bioengineering, 83 (3), 253-260).

The contact surface between yeasts and wine did thus range from 1.4 10¹⁰* 80 to 8.9 10¹¹* 80 i.e. from 1 10¹² to 7 10¹³ μm²/L, in the present tests given as an illustration.

### EXAMPLE 8

### Evaluation of Non Viable Yeasts Capable to Rapidly Consume Oxygen Other than Dregs and Comparison Between the Non Viable Yeasts (Inactivated Through Chemical Treatment) and the Viable Yeasts Implemented

### A. Material and Methods

### A.1. Preparation:

A same batch of active dried yeasts (strain EC1118, Lallemand, Blagnac) is incorporated into alginate in a viable or a non viable form (thermal inactivation for 5 minutes at 74° C., i.e. log UP of 2.48) and deposited onto natural latex beads. These latex beads are placed in 1-liter capacity white bottles, filled with wine to the half. The white wine that is used is a non sulfite-containing Sauvignon wine.

The yeast cell concentration per bottle is of about 2×10¹⁰ cells, distributed on the surface of about twenty latex beads. The bottles are sealed with polyethylene tight plugs and incubated at 20° C. for 500 hours.

### A.2. Dissolved Oxygen Measurements:

We used the fluorescence-based PRESENS system, model 5 Fibox3 Trace-V3. Two reference dots SB3 of about 5 mm diameter are stuck inside each bottle used (one in the gas phase, the other in the liquid phase). The oxygen measurement is directly carried out using an optical fiber through the glass. The dissolved oxygen value in a bottle filled with water to saturation is used for the daily calibration.

### A.3. Turbidity Measurements:

The wine final turbidity is measured by means of a HACH turbidimeter (model 58357-00).

### B. Results

### B.1. Oxygen Consumption and Turbidity:

Although viable yeasts have oxygen consumption activities substantially equal to those observed with the thermally inactivated cells, it clearly appears (Table 1) that encapsulating viable yeasts in alginate results in a non negligible release of yeasts in the medium (significant increase in the wine turbidity), which does not occur with inactivated yeasts. This release in the medium corresponds to a low growth of the viable yeasts within the alginate layers and to the dissemination of these strains in wine. This phenomenon is detrimental to the end quality of the finished product.

TABLE 14
Amounts regarding the initial and final seeded population
per bottle, the medium turbidity and the dissolved oxygen
consumed after 500 hours of incubation at 20° C.

| | Initial | Final | | Total consumed |
|---|---|---|---|---|
| | population | population | Turbidity | dissolved |
| | (cells/ml) | (cells/ml) | (NTU) | oxygen (mg/L) |
| Viable yeasts | 3.4 × 10⁷ | 10.54 × 10⁷ | 18 | 1.24 |
| Thermally | 5.8 × 10⁷ | 5.0 × 10⁷ | 7 | 1.61 |
| inactivated | | | | |
| yeasts | | | | |
| Wine alone | 0 | 0 | 5 | 0.86 |

1. A composition for protecting from oxidation a dietary aqueous liquid, which contains substances sensitive to oxidation during the shelf-life thereof comprising a combination of two types of yeast cells:
(i) non-viable yeast cells capable of rapidly consuming oxygen, said yeast cells having an oxygen consumption rate of at least 5 ng O₂. s⁻¹ for 10¹⁰ yeast cells when present at a concentration of about 10⁸ cells/ml in a hydroalcoholic buffer, and
(ii) inactivated yeast cells enriched with glutathione.

2. A composition according to claim 1, wherein said dietary aqueous liquid is a fermented drink.

3. A composition according to claim 1, wherein said dietary aqueous liquid is a wine.

4. A composition according to claim 1, wherein said liquid is a white wine.

5. A composition according to claim 1, wherein said non-viable yeast cells capable of rapidly consuming oxygen consist in yeast dregs obtained from fermentation.

6. A composition according to claim 1, wherein said non-viable yeast cells capable of rapidly consuming oxygen are of the Saccharomyces cerevisiae species.

7. A composition according to claim 1, wherein said inactivated yeast cells enriched with glutathione are yeasts of the enological type.

8. A composition according to claim 1, wherein said inactivated yeast cells enriched with glutathione are yeasts of the Saccharomyces family.

9. A composition according to claim 1, wherein said inactivated yeast cells enriched with glutathione are capable of releasing in the medium where they are incorporated a glutathione amount of at least 1% of glutathione by weight relative to the yeast dry matter total weight.

10. A composition according to claim 1, wherein said yeast cells are included in an immobilization system pervious to said liquid made of a material compatible with food standards.

11. A composition according to claim 10, wherein said immobilization system is selected from the group consisting of membrane capillaries, silicone tubes and alginate in the form of beads or spaghettis.

12. A composition according to claim 10, wherein said immobilization system is alginate in the form of beads or spaghettis.

13. A method for stabilizing, during the shelf-life thereof, a dietary aqueous liquid, containing substances sensitive to oxidation, comprising contacting the medium composed of said liquid with a composition according to claim 1.

14. A method according to claim 13, wherein said yeast cells are included in an immobilization system pervious to said liquid made of a material compatible with food standards and wherein the contact surface between yeasts implemented in the immobilization system and said dietary aqueous liquid is of at least 10¹² μm²/L and is homogeneously distributed within all the said liquid, when the dissolved oxygen amount in said dietary aqueous liquid is of at least 0.1 mg/L of said liquid.

15. A method according to claim 13, wherein said yeast cells are included in an immobilization system pervious to said liquid made of a material compatible with food standards and wherein the contact surface between the yeasts implemented in the immobilization system and said dietary aqueous liquid is of at least 10¹² μm²/L and is higher at the contact points between said liquid and the oxygen penetration points in the container, when the dissolved oxygen amount in said dietary aqueous liquid is of at most 99 μg/L of said liquid.

16. A final white wine prepared according to the method of claim 13, without any naked-eye detectable browning, which has an oxydoreduction potential at most equivalent to the oxydoreduction potential prevailing at the time of its conditioning and concentrations of compounds impacting on the organoleptic properties of said wine at least equal to those concentrations of said compounds prevailing at the time of its conditioning.

17. Use of the composition according to claim 1 for preserving from oxidation effects liquids containing substances sensitive to oxygen during the shelf-life thereof.

18. A composition according to claim 1, wherein said non-viable yeast cells capable of rapidly consuming oxygen are of the Saccharomyces cerevisiae species and wherein said inactivated yeast cells enriched with glutathione are yeasts of the Saccharomyces family.

19. A method according to claim 13, wherein said dietary aqueous liquid is white wine.

20. A method for stabilizing, during the shelf-life thereof, a dietary aqueous liquid, containing substances sensitive to oxidation, comprising contacting the medium composed of said liquid with a composition according to claim 10.
